(19) United States
(12) Patent Application Publication
(10) Pub. No.: US 2003/0133746 A1
(43) Pub. Date: Jul. 17, 2003

(54) SAFE AUTOMOBILE TOWING STRUCTURE

(76) Inventor: Hsin-Yuan Pan, Taipei City (TW)

Correspondence Address: BACON & THOMAS, PLLC, 625 SLATERS LANE, FOURTH FLOOR, ALEXANDRIA, VA, 22314

(21) Appl. No.: 10/044,943

(22) Filed: Jan. 15, 2002

(51) Int. Cl. F16D 1/00; B25G 3/18; F16B 21/00

(52) U.S. Cl. 403/322.2

(57) ABSTRACT

The present invention relates to a safe automobile towing structure, which contains a connecting rod with a flashing alarm at each side. On each end of the connecting rod is an extension rod, which end is installed with a rotational base. At the connection, the rotational base and the extension rod are mutually installed with a rotational axle. The rotational path between the rotational base and the extension rod is installed with corresponding bumpers. An adjusting rod is installed at the end of the rotational base. At the connection, the adjusting rod and the rotational base are mutually installed with a revolving axle that is perpendicular to the rotational axle. Besides, the vertically rotational path is installed with corresponding bumpers. The end of the adjusting rod is installed with a fastening device, which can be used to connect the front towing hook and the rear towing hook for the convenience of towing work.

### BACKGROUND OF THE INVENTION

### DESCRIPTION OF THE PRESENT INVENTION

1. Field of the Invention

The present invention relates to a safe automobile towing structure, especially a device used for small cars, which is a new structural design that can be dissembled for easy carriage when it is not used and assembled by a DIY (Do It Yourself) method to be an integrated object with stability provided for towing and warning given to surrounding people and cars to assure every aspect of the safety.

2. Description of the Prior Art

With increasing living standard, it is not hard for a family to own a car. Some families even have more than one car. This causes a significant increase of car density on the street. Although cars bring a lot of convenience to our daily life, at the same time they make some troubles for us and result in adverse circumstances for the car owners and many others. A car breakdown is a headache but also an inevitable thing. Particularly because of large size, heavy weight and the specialized skills involved in car repair, most time ordinary people can not repair the broken car by themselves. Instead, they can only move the broken car to a garage and have professionals to do the repair. Therefore, towing a broken car is a serious matter for car owners.

On the streets, people usually ask professional towing companies to handle the towing work. This is not only expensive but also unfeasible for remote area that no towing service is available. Hence, presently the most popular way to tow a car is first to find a car of the same model or a car with larger size, followed by tie a steel rope between the two cars, so the normal car can tow the broken car by the steel rope. However, because the towing tool is a steel rope, some of the following accidents may happen:

1. Because of the elastic force generated by the steel rope when the front car is pulling the rear car, the rear car may not react to move simultaneously and causes a collision with the front car by a sudden forward rush.

2. Similarly, when the front car suddenly stops, the rear car will rush forward and hit the front car.

3. When the steel rope is overloaded, it won't break immediately, which misleads the driver to think the rope works well. As the car is still moving, a sudden breakage of the steel rope can make the car out of control and result in danger.

4. The steel rope swings when the car is moving. Besides, when the front car is making a turn, the movement of the rear car is hard to control. These add difficulties to towing a car.

In addition, most people do not display the warning signs when they are towing a car. Pedestrians or other cars may approach without careful attention. Further, the swinging of the towed car may cause accidents by colliding with other cars. In view of the above description, the above-mentioned traditional object still has many shortcomings and is not considered as a good design, so it is in an urgent need of improvement.

The inventor for the present invention has been involved in car maintenance for several decades, during which he has seen many tragedies caused by the above-mentioned accidents. Therefore, the inventor is dedicated to the investigation of various shortcomings found in the traditional car towing structure and eagerly seeks improvements and innovations. Further, the inventor successfully accomplishes a safe automobile towing structure in the present invention.

### SUMMARY OF THE INVENTION

The objective of the present invention is to provide a safe automobile towing structure that uses a hard rod to connect the front car and the rear car. No matter how the front car moves, the stability of the broken car can be maintained and road safety is assured.

Another objective of the present invention is to provide a safe automobile towing structure, wherein a horizontal or vertical revolving axle is installed at each connecting end, which functions well even for a large turn; besides, a restriction is put on the turning angle, so it will not be too large to affect the car movement.

Another objective of the present invention is to provide a safe automobile towing structure, wherein a flashing alarm giving off light and sound is installed to warn other people or cars to keep in a distance and prevent accidents caused by poor visibility or carelessness.

Another objective of the present invention is to provide a safe automobile towing structure, which is assembled in a DIY way so the dissembled parts can be stored in a holding box with minimized space and ease of immediate use.

### BRIEF DESCRIPTION OF THE DRAWINGS

The drawings disclose an illustrative embodiment of the present invention that serves to exemplify the various advantages and objects hereof, and are as follows:

FIG. 1 is the three-dimensional disassembled diagram for the present invention;

FIG. 2 is the three-dimensional assembled diagram for the present invention;

FIG. 3 is the illustrative example of the holding box for the present invention;

FIG. 4A is a structural decomposition for the fastening device in the present invention;

FIG. 4B is a structural assembly for the fastening device in the present invention;

FIGS. 5A, 5B and 5C are illustrative examples decomposition for the fastening device in the present invention;

FIG. 6A is an illustration before the action of the fastening device in the present invention;

FIG. 6B is an illustration when the action of the fastening device is completed in the present invention;

From FIG. 7A to FIG. 7D are illustrations for four different hooks in the present invention;

FIG. 8A is a crossectional view for an embodiment that indicates connection between the rotating base and the adjusting rod;

FIG. 8B is a three-dimensional view for an embodiment that indicates connection between the rotating base and the adjusting rod;

FIG. 8C is an illustration that shows the motion of the thorn teeth and the buckling block for the present invention;

FIG. 9 is an illustration for the flashing alarm that gives light and sound in the present invention;

FIG. 10 is an illustration for the elastic orientation adjusting base in the present invention; and

FIG. 11 is an illustration for an embodiment that shows the action of the operation rod in the present invention.

[Legends for the Main Components]

| | | | |
|---|---|---|---|
| 1 | Connecting rod | 10 | Holding box |
| 11 | Screw aperture | 12 | Holding box |
| 2 | Extension rod | 21 | Bolt |
| 3 | Rotational base | | |
| 4 | Adjusting rod | 41 | Screw aperture |
| 5 | Fastening device | 50 | Towing hook |
| 50a | Towing hook | 50b | Towing hook |
| 50c | Towing hook | 50d | Towing hook |
| 51 | Bolt | 52 | Handle |
| 53 | Screw | 54 | Fastener |
| 541 | Clamping arm | 542 | Positioning pillar |
| 543 | Spring | 544 | Retainer |
| 545 | Safety bolt | 546 | Spring |
| 547 | Guide arch | 591 | Blocking blade |
| 55 | Adjusting cap | 56 | Tightening device |
| 57 | Extension rod | 58 | Spring |
| 59 | Fixed sleeve | 6 | Lighting alarm |
| 61 | Screw | 62 | Speaker |
| 63 | Warning light | 64 | Image sensor |
| 65 | Control switch | 71 | Rotational axle |
| 72 | Rotational axle | 73 | Axle center |
| 731 | Oilet | 732 | Oil passage |
| 74 | Revolving axle | 75 | Revolving axle |
| 76 | Thorn teeth | 77 | Cushion block |
| 771 | Groove | 772 | Spring |
| 773 | Buckling block | 60 | Operation rod |
| 81 | Bumper | 82 | Bumper |

### DETAILED DESCRIPTION OF THE PREFERRED EMBODIMENT

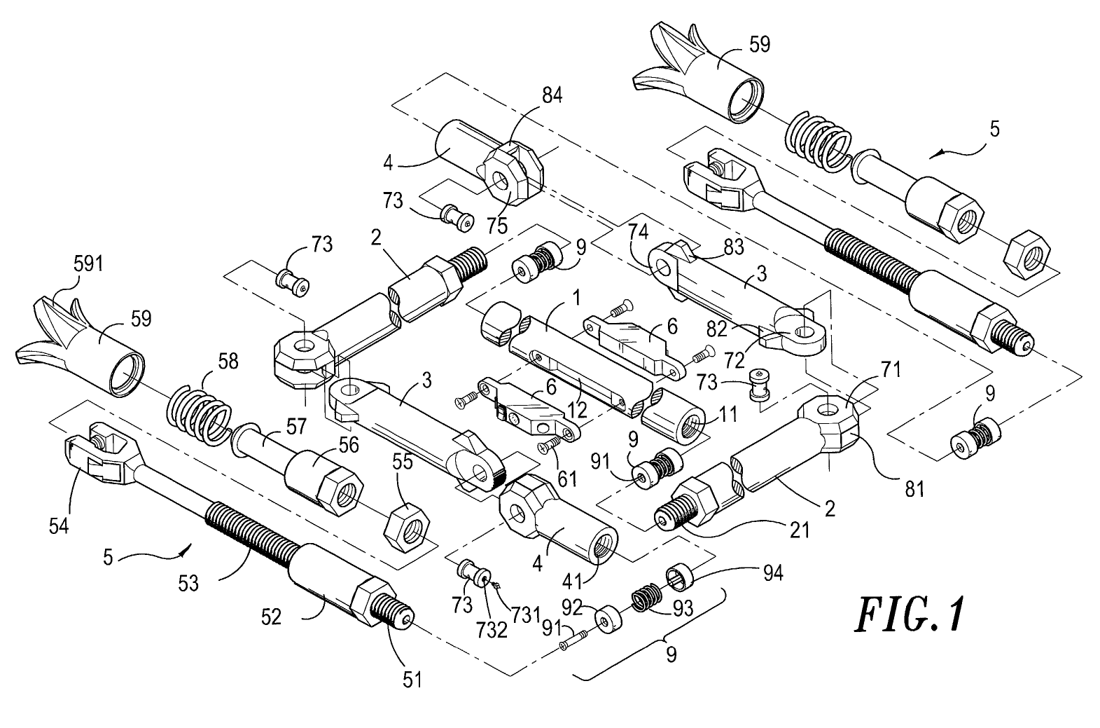

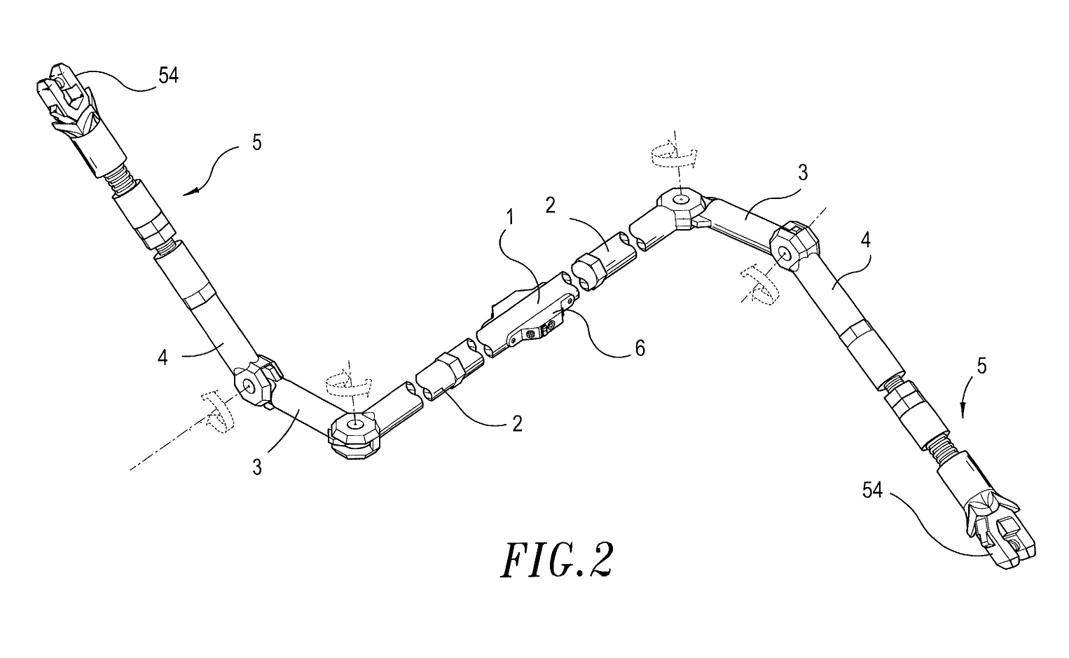

Please refer to FIG. 1 and FIG. 2 for the safe automobile towing structure provided in the present invention, which mainly includes a connecting rod 1, two extension rods 2, two rotational bases 3, two adjusting rods 4, two fastening devices 5 and two flashing alarms 6. Wherein, the two extension rods 2, the two rotational bases 3, the two adjusting rods 4 and the two fastening devices 5 are installed at the opposite ends of the connecting rod 1 and can be assembled or disassembled in the order as connecting rod 1, extension rod 2, rotational base 3, adjusting rod 4, fastening device 5. Although the two flashing alarms 6 are installed at the opposite ends of the connecting rod 1, only the description of installation at a single end is given in the following.

The connecting rod 1 is a vertical rod with screw apertures 11 at both ends. The extension rod 2 connects to one end of the connection rod 1 and has a bolt 21 at the place corresponding to the screw aperture 11, which makes the extension rod 2 to lock in or move out of the connecting rod 1. At the connection, the extension rod 2 and the rotational base 3 are mutually installed with the rotational axles 71 and 72, inside which there is the axle center 73. So the rotational base 3 can rotate around the extension rod 2. To avoid the stress induced damage due to the relative rotation between the extension rod 2 and the rotational base 3, the rotational axle 71 can be enlarged and fringed as reinforcement. On the rotational path for the extension rod 2 and the rotational base 3, there are bumpers 81 and 82 to limit the rotating angle for the rotational base 3. At the connection, the rotational base 3 and the adjusting rod 4 are mutually installed with the revolving axles 74 and 75, inside which there is the axle center 73 to make the revolving axles 74 and 75 perpendicular to the rotational axles 71 and 72. So the adjusting rod 4 can rotate around the rotational base 3. The rotational axle 75 has the same reinforcing structure as the rotational axle 71. Besides, on the vertical rotational path for the rotational base 3 and the adjusting rod 4, there are corresponding bumpers 83 and 84 to limit the swinging angle for the adjusting rod 4. The above-mentioned rotational axles 71, 72 can be installed in an exchangeable way. Similarly, the revolving axles 74, 75 can also be installed in an exchangeable way to have the identical function. The connection between the adjusting rod 4 and the steel rod base 5 has a screw aperture 41. The steel rope base 5 has a bolt 51 corresponding to the screw aperture 41. The steel rope base 5 has a screw shaft 52 corresponding to the other end of the bolt 51. At the front end of the screw shaft 52, there is a steel rope ring sleeve 53, which rear end has a fastener 54. An adjusting screw cap 55 is installed on the screw 53. At the rear end of the adjusting cap 55, there is a tightening device 56, at the rear end of which there is an extension rod 57, on which there installs a spring 58. At the rear end of the spring 58, there is a fixed sleeve 59. The spring 58, the tightening device 56, the extension rod 57 and the adjusting screw cap 55 are all formed on the screw 53 during production. The fastener 54 can be used for connection with the towing hook. The tightening device 56 presses the fixed sleeve 59 to cover the fastener 54 to avoid loose connection. Therefore the safety is assured. The above-mentioned fixed sleeve 59 has radiating petal-shaped blocking blades 591, which appear in arch shape to avoid damage to the fastener 54. In addition, inside the screw aperture 11 and 41 for the connecting rod I and the adjusting rod 4 there are elastic orientation adjusting bases 9, which are fastened to the screw apertures 11 and 42 by screws 91 to make proper elastic adjustment of the rod rotational angle between the two sides of the elastic orientation adjusting bases 9.

After the completion of the above-mentioned safe automobile towing structure, the assembling proceeds with the steel rope bases 5 at both ends fastened to the couplings of the front and the rear cars. Then the towing work starts right away. When cars are making turns or changing lanes, the bumpers 81 and 82 maintain proper turning angles for the front car and the rear car. For bumping land surface, previously mentioned bumpers 83 and 84 are provided with the same structure as the bumpers 81 and 82. The bumpers 81, 82, 83 and 84 on previously mentioned extension rod 2, rotational base 3 or adjusting rod 4 have contact surface in 45 degree to limit the relative rotating angle for the two neighboring rods less than 90 degree. The accidental collision between the front car and the rear car can be avoided in such way so the safety is assured when the car is moving.

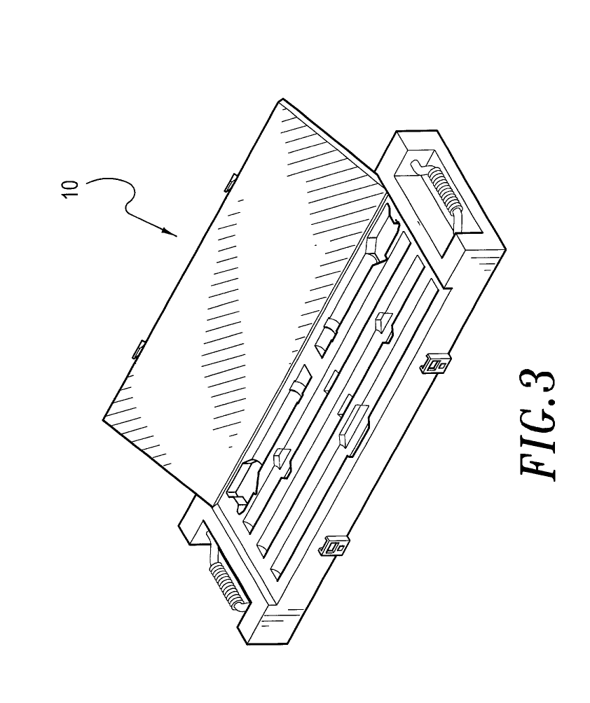

Please refer to FIG. 3 for previously mentioned assembling or disassembling in a DIY way. The disassembled parts can be stored in a holding box 10 for a systematic and space-saving classification and storage. So the holding box 10 can be easily put in the trunk or limited space for instant use.

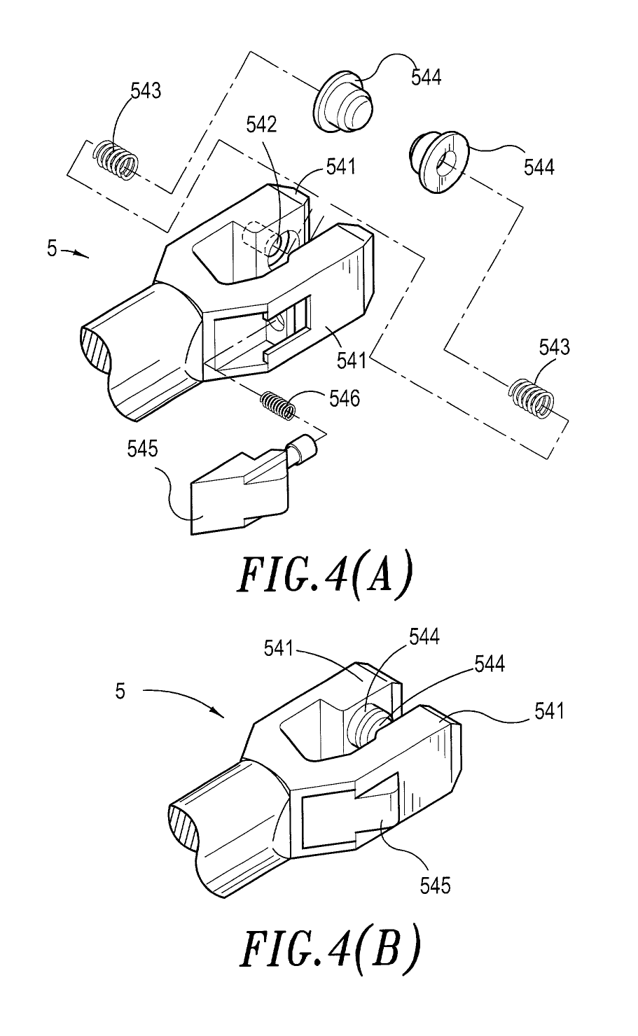

Please refer to FIG. 4A and 4B, at the front end of the fastener 54, there are two clamping arms 541, inside which there is a positioning pillar 542, on which there installs a spring 543, which holds a retainer 544, so the retainers 544 of the two clamping arms 541 can extend on each other. At the rear end of at least one clamping arm, there is a safety bolt 545, inside which there is a spring 546 to lock the rear end of the safety bolt 545 into the rear end of the retainer 544.

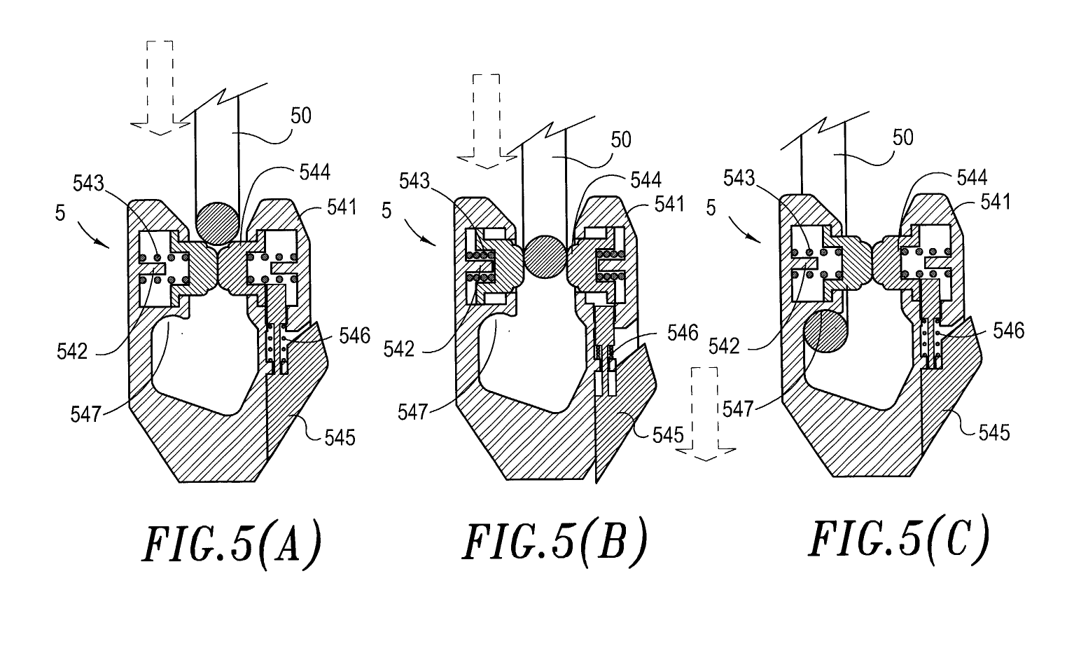

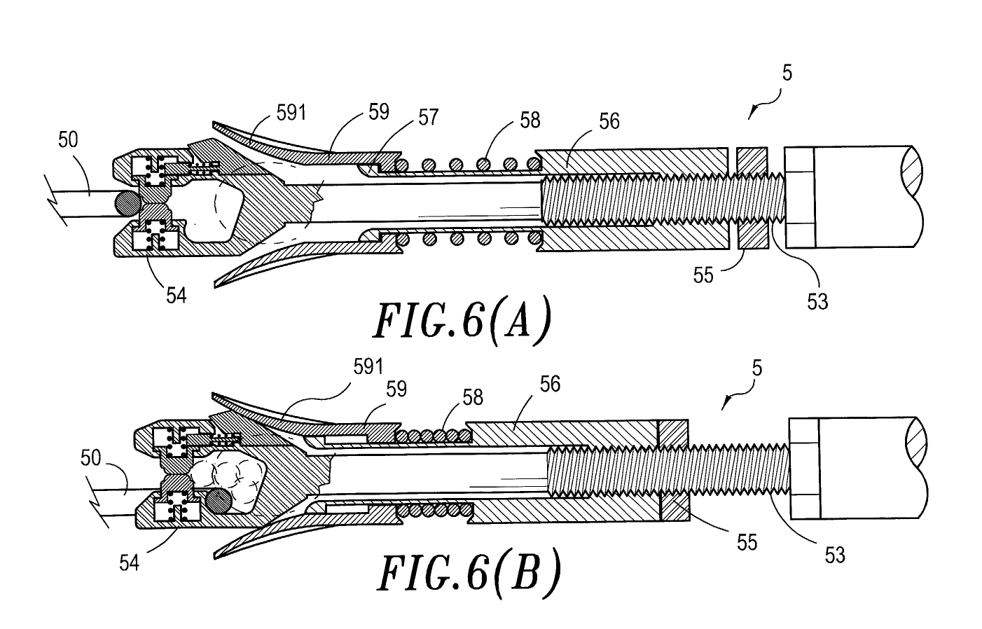

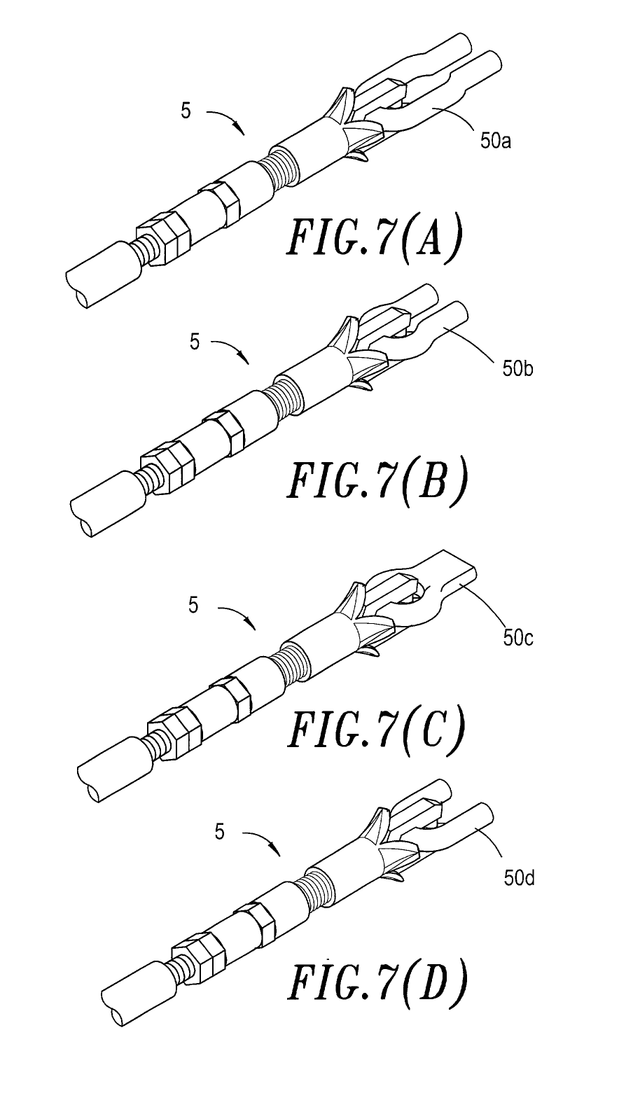

Please refer to FIG. 5A, 5 B and 5 C for the connection method for the fastener 54 in the present invention. First, lift the safety bolt 545 up and backward. Push in the fastener 54 by aiming it to the towing hook 50. The two retainers are forced to slide into the clamping arms 541. When the towing hook 50 completely enters the two clamping arms 541, the two retainers 544 return by elastic spring 543 to connect tightly. Again by release of the spring 546, the safety bolt 545 is pushed back to immobilize the retainers 544 and complete the action of the fastener 54. There is a guide arch 547 inside the fastener 54 to reinforce the action of the towing hook 50. Please refer to FIG. 6A and 6 B, after the above-mentioned fastener 54 completes its action, the tightening device 56 pushes it forward. Through the spring 58 on the extension rod 57, the fixed sleeve 59 is pushed forward. So the fastener 54 is covered to prevent loose connection. After the fixed sleeve 59 lies against the fastener 54, the spring 58 is properly adjusted to make tight connection. Finally, the adjusting cap 55 is used to lock the retainer 56 to a fixed position and completes the action of fastener. The above-mentioned towing hooks basically include several models as shown from FIG. 7A to FIG. 7D. The towing hooks 50a, 50b, 50c and 50d are typical models for small cars. Hence, the present invention is aimed at the towing of small cars.

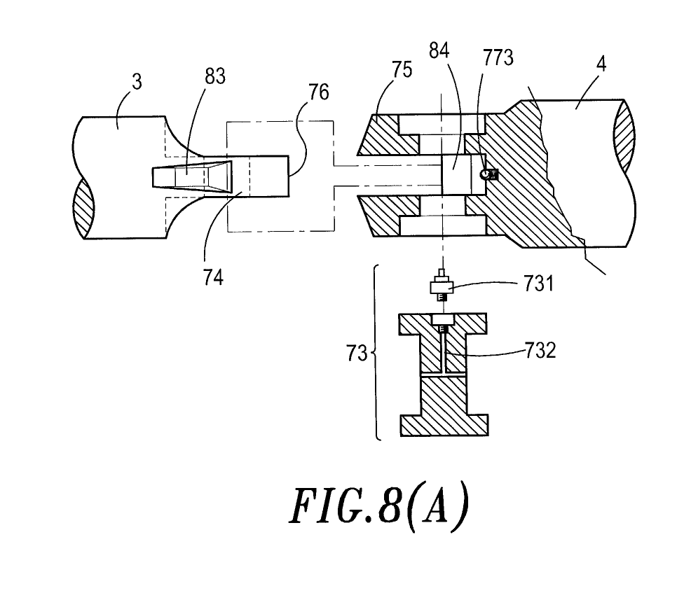

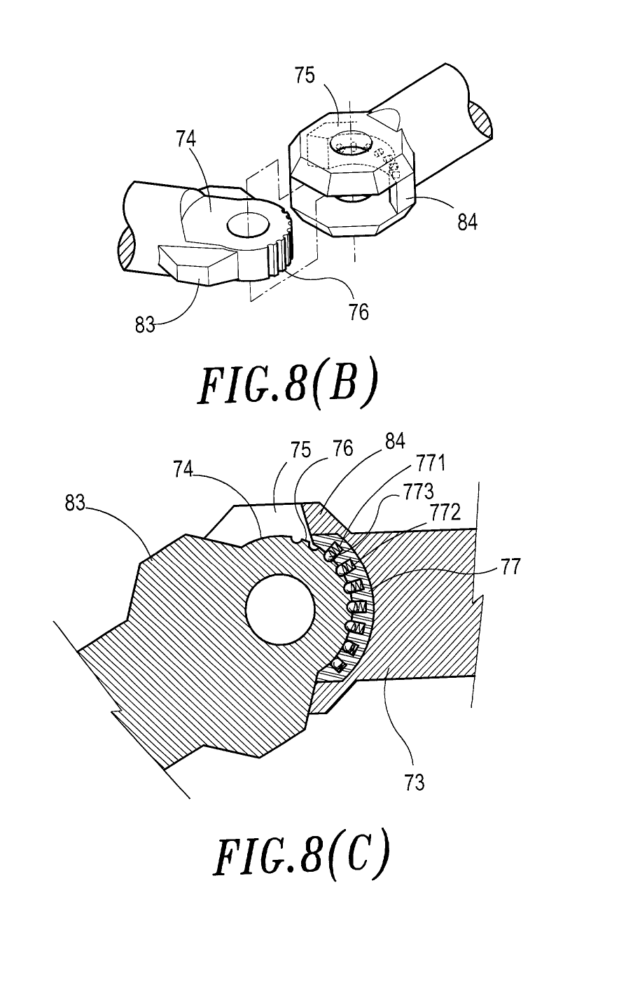

Please refer to FIG. 8A, FIG. 8B and FIG. 8C for maintaining smooth rotation when the extension rod 2 and the rotational base 3 move left and right during towing process. However, the rotational base 3 and the adjusting rod 4 swing vertically at a rather small angle. So the present invention installs thorn teeth 76 on the revolving axle 74 of the rotational base 3. Correspondingly, inside the rotational axle 75 of the adjusting rod 4, there is a cushion block 77, inside which there are several grooves 771, inside which there are several springs 772. The front of the said springs is buckling block 77, which are used to lock the thorn teeth 76. The rotational base 3 and the adjusting rod 4 can maintain a stable towing action under normal condition, while enhances the towing stability for a car to move on a bumping land surface by a stepwise adjustment for a proper angle. When the spring 772 or the buckling block 773 is worn out, replacement can be done by direct removal of the cushion block 77 to reduce the maintenance cost. Further, an oilet 731 is installed at the exterior of previously mentioned axle center 73. At the rear end of the oilet 731, there is an oil passage 732, which can lead the lubricant into the rotational axles 71, 72 and the revolving axles 74, 74 to maintain smooth rotation.

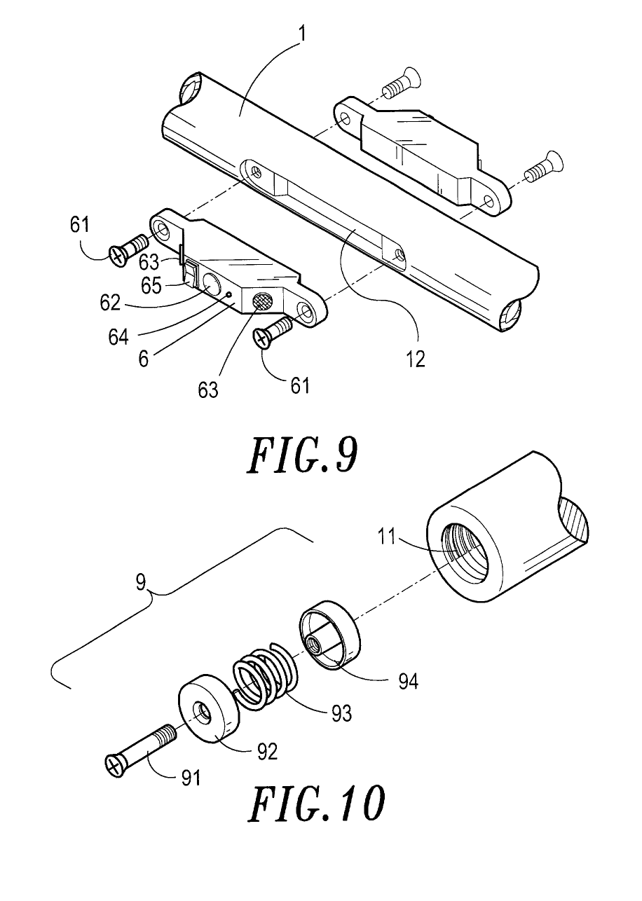

Please refer to FIG. 9 for the flashing alarm 6, which has a speaker 62, a warning light 63, an image sensor 64 and a control switch 65 and is powered by batteries. Wherein, the control switch 65 has a three-step control method as follows: the first step is to turn on the speaker 62 and the warning light 63; the second step is to turn on the warning light 63 with simultaneous activation of the image sensor 64, followed by turning on the speakers 62 if human or cars are approaching; the third step is to turn off the circuit. The warning light 63 can also be adjusted for its color, intensity or flashing mode. The speakers 62 can be adjusted for its volume or tone. Besides, the speakers 62 and the warning light 63 can be adjusted for their quantity.

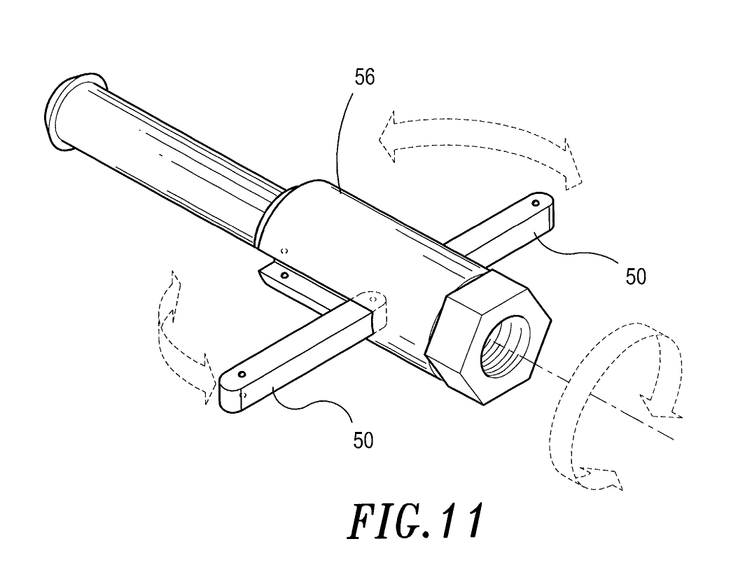

Please refer to FIG. 10 for previously mentioned adjusting base 9, which contains a top cover 92, a spring 93 and a bottom cover 94. A screw 91 is used to penetrate the top cover 92, the spring 93 and the bottom cover 94 and is fastened on the connecting rod 1 or the adjusting rod 4. The said top cover 92 and the bottom cover 94 have concavity for holding the spring 93. The angle between the two ends of the elastic orientation-adjusting base 9 can be properly adjusted by the spring 93 even when the rod components are fastened. Thus, the flashing alarm 6 on the connecting rod 1 can be maintained on both sides of the car to provide the best warning effect without declination.

Please refer to FIG. 11. For easy operation, the expanding sleeve 56 surface of the steel rope base 5 has the operation rods 60 on opposite sides. The operation rods 60 can be folded in the expanding sleeve 56. The operation rods 60 open to both sides during use to form a wrench-like device, which can rotate the operation rods 60 along the rotational direction of the expanding sleeve 56, so the steel rope base 5 can be firmly hung to the coupling 50.

When compared to the traditional technology, the safe automobile towing structure provided in the present invention has the following advantages:

1. The present invention provides a safe towing function that a broken car can be safely towed without swinging to prevent road accidents.

2. The present invention is applicable to every kind of road condition, even at a large angle turn, without space limitation.

3. The present invention can provide warning to other people and cars to prevent them from mistakenly getting into the towing range and to minimize the accidents.

4. The present invention provides the ease of carriage and fast assembling during use, so road blockage is avoided and smooth road condition is maintained. This promotes the widespread use of the invention.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A safe automobile towing structure, which includes:
a connecting rod with screw apertures at both ends and a flashing alarm on each side of said connecting rod surface;
two extension rods, installed at both ends of said connecting rod, with a bolt at a front end of each extension rod corresponding to said screw aperture of said connecting rod;
two rotational bases, installed respectively at rear ends of said two extension rods, with rotational axles mutually installed at connection between a front end of each revolving axle and said extension rod, fastened by an axle center, and corresponding bumpers on a rotation path for said rotational base and said extension rod so that a rotation angle is limited during rotation;
two adjusting rods, installed respectively at rear ends of said two rotational bases, with revolving axles mutually installed at said connection between a front end of said adjusting rod and said rotational base, fastened by said axle center to be perpendicular to said rotational axle, and corresponding bumpers on a vertical rotation path for said adjusting rod and said rotational base so that said rotation angle of said adjusting rod with said screw aperture at its rear end is limited during rotation;
two steel rope bases, installed respectively at said screw apertures of said two adjusting rods, with a corresponding bolt to said screw apertures at said steel rope base, and a screw shaft corresponding to the other end of said bolt, and a steel rope ring at a front end of said screw shaft, and a fixed sleeve at a rear end of said steel rope ring, and at a rear end of said fixed sleeve an expanding sleeve of screw threads that can rotate and move along said screw shaft, and a retainer that can be fastened to said fixed sleeve, and a spring between said fixed sleeve and said expanding sleeve, and a nut at a rear of said expanding sleeve;
two fasteners, installed respectively at said screw apertures of said two adjusting rods, with screw bolts installed at places corresponding to said screw apertures, and a handle connected to a rear of said bolt, and a screw connected to a rear of said handle, and said retainer connected a rear of said screw, and an adjusting cap on said screw, and a tightening device at a rear of said adjusting cap, and said extension rod at a rear of said tightening device, and said spring on said extension rod, and said fixed sleeve at a rear of said spring, and two clamping arms at a front of said fastener, and a positioning pillar inside each clamping arm, and said spring on each positioning pillar, and said retainer pushed by said spring to be extendible, and a safety bolt at a rear of one clamping arm, and said spring through said safety bolt to lock said bolt with a rear of said retainer.

2. The safe automobile towing structure of claim 1, wherein petal-shaped blocking blades are installed at a front end of said fixed sleeve of said steel rope base with arc surface on blocking blades to avoid damages to said steel rope ring.

3. The safe automobile towing structure of claim 1, wherein said extension rod, said rotational base or said bumpers on said adjusting rods appear in 45 degree to limit said relative rotational angle for said two neighboring rods less than 90 degree.

4. The safe automobile towing structure of claim 1, wherein inside said screw apertures of said connecting rod or said adjusting rod is an elastic orientation adjusting base containing a top cover, a spring and a bottom cover with a screw to penetrate said top cover, said spring and said bottom cover to be fastened inside said screw apertures, so said rotational angle between said rods at two ends of said elastic orientation adjusting base can be adjusted by said spring.

5. The safe automobile towing structure of claim 1, wherein outside said axle center of said revolving axle or said rotational axle is an oilet having oil passage at a rear end to provide said revolving axle or said rotational axle with lubrication.

6. The safe automobile towing structure of claim 1, wherein a holding box is installed to store all disassembled parts in order for providing convenience during carriage and use.

7. The safe automobile towing structure of claim 1, wherein at flashing alarm a holding tank is installed in accordance with a shape of said flashing alarm fastened onto said connecting rod by a screw, and said flashing alarm contains a speaker, a warning light, an image sensor and a control switch powered by batteries, and said control switch is used to activate other components, and said image sensor is used to detect images of humans and cars to control actions of the speaker and said warning light that can have predetermined quantity, types and display mode as necessary.

8. The safe automobile towing structure of claim 1, wherein on said revolving axle of said rotational base are thorn teeth, and correspondingly, inside said rotational axle of said adjusting rod there are cushion blocks, inside which there are several grooves with a spring in each of said groove, and a buckling block is pressed onto a top of each spring so it can be inserted in said thorn teeth to generate stepwise movement.

9. The safe automobile towing structure of claim 1, wherein on opposite two sides of said tightening device of said steel rope base are operation rods capable of being folded in said expanding sleeve and open to both sides during use in rotation with a turning direction of said expanding sleeve.

10. The safe automobile towing structure of claim 1, characterized in that its rotational axles may be enlarged, or said rotational axle or said revolving axle may be fringed as reinforcement.
